(19) United States
(12) Patent Application Publication
(10) Pub. No.: US 2015/0134461 A1
(43) Pub. Date: May 14, 2015

(54) REFERRAL MANAGEMENT METHODS AND APPARATUS

(71) Applicant: Goldenslate, Inc., Campbell, CA (US)

(72) Inventors: Renjith Menon, Campbell, CA (US); Matthew Martin, Santa Clara, CA (US); Philip Peshin, Cupertino, CA (US); Marcia Wallis, San Jose, CA (US)

(21) Appl. No.: 14/501,512

(22) Filed: Sep. 30, 2014

Related U.S. Application Data
(60) Provisional application No. 61/884,703, filed on Sep. 30, 2013.

(51) Int. Cl. G06Q 30/02; G06Q 50/00

(52) U.S. Cl. CPC G06Q 30/0269; G06Q 50/01
USPC 705/14.66

(57) ABSTRACT

A system, method, and apparatus for providing referral management are disclosed. An example method includes receiving a request message from a consumer device of a first member, the request message identifying a service type, determining a group of members that are trusted connections of the first member, determining a subset of the trusted connections that includes trusted connections that have experience with the service type, transmitting a referral request message to consumer devices associated with the trusted connections of the subset, receiving a referral response message including an identifier of a provider of the requested service type from at least one of the client devices that received the referral request message, and transmitting a request response message to the consumer device of the first member including the identifier of the provider.

### PRIORITY CLAIM

The present application claims priority to and the benefit of U.S. Provisional Patent Application Ser. No. 61/884,703, filed on Sep. 30, 2013, the entirety of which is incorporated herein by reference.

### BACKGROUND

Personal referrals typically have the greatest impact on a consumer's purchasing decisions. According to a report by Nielson Media Research, 92% of consumers ask family or friends for a referral prior to making a decision to purchase a service or non-commodity product. As one can appreciate, consumers trust the advice and recommendations of family and friends over strangers.

Despite the popularity of referrals, social media and other Internet-based applications have been unable to successfully facilitate the exchange of referrals between family, friends, or similarly situated groups of consumers. Instead, consumers oftentimes determine whether a product or service is recommended based on direct electronic exchanges (e.g., e-mail, text message, social media post, etc.), phone calls, or actual personal interaction with family/friends. A drawback of these methods is that it is relatively time consuming to query different people and process the cumulative feedback. Another drawback is that the people being queried may not be able to provide an adequate recommendation.

In addition to directly querying family and friends, consumers also scour product or service reviews to determine whether a particular product or service is recommended. For instance, websites that sell a product or service often provide consumer reviews. In other instances, websites provide a collection of independent consumer reviews for different products and/or services. However, in either of these instances, it is difficult for a consumer to determine the accuracy of the reviews, whether the reviews were sponsored, and/or whether the reviewer has the same preferences and/or tastes.

### SUMMARY

The present disclosure provides a new and innovative system, method, and apparatus for providing referral management. For example, a referral server is configured to manage relationships between members and service providers to enable any one member to make a request for referrals of a service and/or product to other members that are trusted connections of the member. The example referral server is configured to use one or more matching algorithms to determine which trusted members are likely to be able to respond to a referral request. The matching algorithms may identify the likely trusted connections based on, for example, common characteristics of the members with the requested service and/or product, previous experience of the connections with the requested product and/or service, other members of the connections that have experience with the requested service and/or product, etc. The example referral server is also configured to manage the collection of referral responses from trusted connections to enable the requesting member to accordingly select a provider and/or product.

In an embodiment, an example referral server includes a relationship processor, a referral processor, and an engagement processor. The example relationship processor is configured to create a personal referral group among a first member and a first plurality of members causing the first member and the first plurality of members to be trusted connections of each other with respect to the personal referral group, the personal referral group created based on one of the first plurality of members inviting the first member become a trusted connection. The example relationship processor is also configured to create a local referral group including the first member and a second plurality of members causing the first and second plurality of members to be trusted connections of each other with respect to the local referral group, the local referral group being created for members with a common background characteristic. The example referral processor is configured to receive from a consumer device of the first member a referral request including a type of provider needed and a location where a service is to be performed, determine whether the referral request is to be transmitted to members within the personal referral group or members within the local referral group based on the type of the provider and the location, and transmit a referral request message to consumer devices of members of the determined referral group. The example engagement processor is configured to receive a response message from at least one of the consumer devices that received the referral request message, the response message including an identifier of a provider of the type of provider specified in the referral request message. The engagement processor is also configured to determine profile information associated with the identifier of the provider and transmit to the consumer device of the first member a request response message including the profile information.

In another embodiment, a method includes receiving at a referral server a request message from a consumer device of a first member, the request message identifying a service type. The method also includes determining a group of members that are trusted connections of the first member, determining a first subset of the trusted connections that includes trusted connections that have experience with the service type, and determining a second subset of the trusted connections that includes trusted connections that are connected to at least one of a member or a provider associated with the service type. The method further includes transmitting a referral request message from the referral server to consumer devices associated with the trusted connections of the first subset and the second subset. Moreover, the method includes receiving at the referral server a referral response message including an identifier of a provider of the requested service type from at least one of the client devices that received the referral request message and transmitting a request response message from the referral server to the consumer device of the first member including the identifier of the provider.

Additional features and advantages of the disclosed system, method, and apparatus are described in, and will be apparent from, the following Detailed Description and the Figures.

### BRIEF DESCRIPTION OF THE FIGURES

FIG. 1 shows a diagram of a relationship chart of actors that are included within a hosted referral service, according to an example embodiment of the present disclosure.

FIG. 2 shows a block diagram of an example referral environment for providing referrals to members, according to an example embodiment of the present disclosure.

FIG. 3 shows a diagram of functions that are provided by a referral server and/or an application of FIG. 2 to members, according to an example embodiment of the present disclosure.

FIG. 4 shows a diagram of functions that are provided by the referral server and/or the application of FIG. 2 to providers, according to an example embodiment of the present disclosure, according to an example embodiment of the present disclosure.

FIGS. 5 and 6 show diagrams of example relationships among members, providers, trusted connections (e.g., Friends) and groups (e.g., local community), according to an example embodiment of the present disclosure.

FIG. 7 shows a flow diagram illustrating example procedures operated by the example referral server of FIG. 2 based on which function is selected by a member, according to an example embodiment of the present disclosure.

FIGS. 8 to 14 show diagrams of example user interfaces of a consumer device displaying referral information provided and/or managed by the referral server of FIG. 2, according to an example embodiment of the present disclosure.

FIGS. 15 to 17 show diagrams of user interfaces that include third-party content displayed in conjunction with referrals managed by the referral server of FIG. 2, according to an example embodiment of the present disclosure.

FIGS. 18 and 19 show diagrams of electrical and software systems of an example computing device (e.g., a referral server, a consumer device, a provider server of FIG. 2), according to an example embodiment of the present disclosure.

### DETAILED DESCRIPTION

The present disclosure relates in general to a method, system, and apparatus to manage referrals, and in particular, to providing a social media-based framework that enables consumers to relatively easily request and receive referrals from other trusted (or otherwise associated) consumers. In particular, a hosted social media website and/or application enables consumers to register as a member and enables the registered members to connect or otherwise associate with other members as trusted connections. The association between members (e.g., trusted connections) can be based on family relationships, friend relationships, or relationships based on a common background characteristic (e.g., a geographic location, a profile trait, a demographic characteristic, a hobby, an education institution attended, a common previous purchases of products and/or services, a profession, a personal interest, etc.). For example, a member may request to associate or connect with other members that share a similar address. Collectively, associated family, friends, acquaintances, and other consumers that share similar background characteristics are selected by a member as trusted connections.

As disclosed herein, the hosted referral service is configured to manage referrals for any type of product or service. For example, the referral service can manage referrals for non-commodity products including, for example, vehicles, appliances, designer clothing, specialized sporting goods, cutting edge electronics, etc. The referral service is also configured to manage referrals for commodity products including, for example, beverages, food, everyday clothing, etc. The referral service can further be configured to manage referrals for services including, for example, tax preparation services, real estate services, healthcare services, legal services, restaurants, etc.

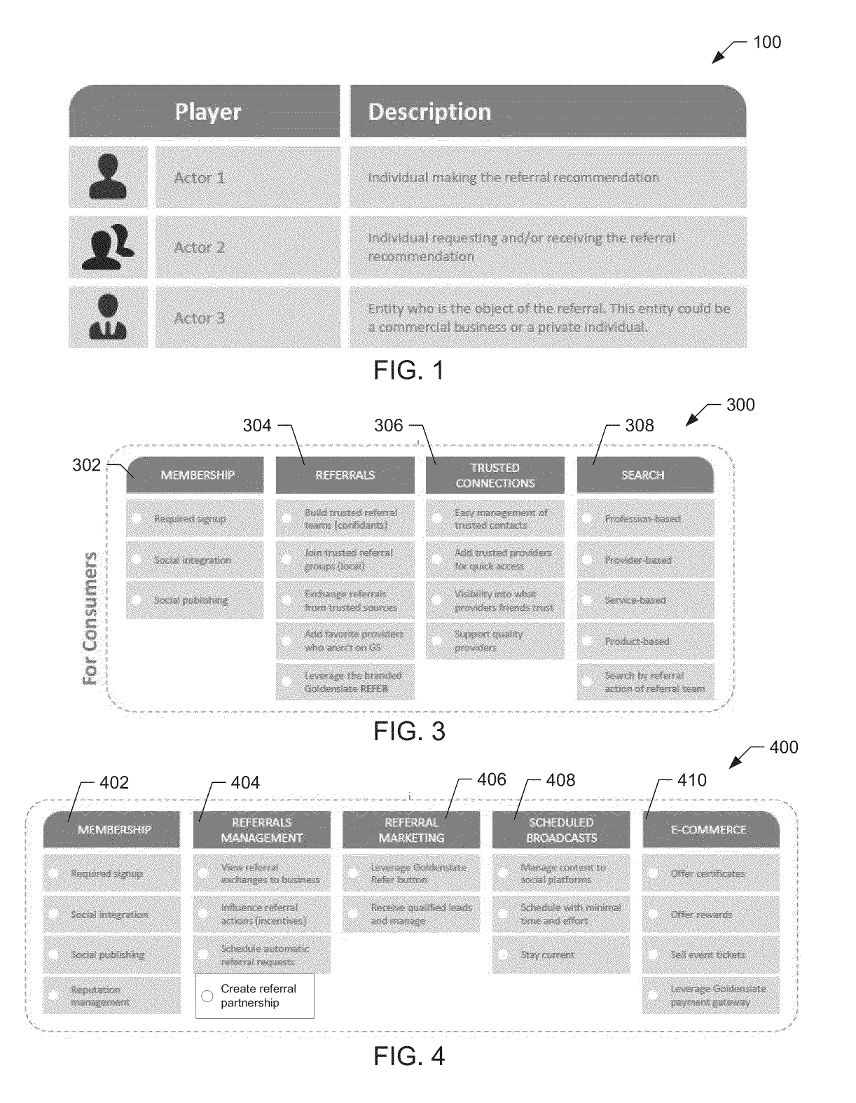

FIG. 1 shows a diagram of a relationship chart 100 of actors that are included within a hosted referral service discussed in more detail below. In this example, Actor 1 and Actor 2 are trusted connections of each other. Actor 2 corresponds to a member of the referral service that requests a referral recommendation. Actor 1 corresponds to another member of the referral service that provides a referral recommendation in response to the request from Actor 2. Actor 1 accordingly provides Actor 2 a referral recommendation for a product and/or service that is considered trustworthy by Actor 2 because Actor 1 is a trusted connection. Actor 3 is an entity (e.g., a service provide or manufacturer of a product) that is an object of the referral recommendation made between Actor 1 and Actor 2.

As disclosed herein, a member is a consumer who is a registered member of a hosted referral service. To become a registered member, the referral service requires that a consumer provide contact information (e.g., an address), profile information (e.g., bibliographic information), hobbies, etc. A consumer may also become a member by integrating an account from another social media provider including, for example, Facebook®, Google+®, Linkedin®, etc. Further, members may provide an e-mail address and/or social media account to enable the hosted referral service to search for potential trusted connections and/or previous purchases of products/services. For instance, the hosted service may analyze a member's e-mail account for receipts of purchased services. The hosted service may then prompt the member as to whether the member would like to have those service providers be included within a list of referred service providers.

As disclosed herein, a trusted connection is a member of the hosted service with whom a link, connection, or association is established. The hosted service enables members to send referral requests to trusted connections. This accordingly ensures that members receive referral requests from other known or otherwise trusted members. In some instances, trusted connections may be added based on a particular group to which those members subscribe or other belong. For instance, some members may join a group specifically created for residents of the West Loop in Chicago, Ill. A member who is part of this group may add the entire group as a trusted connection, which makes each of the members of the group trusted connections. The use of groups enables a member to transmit a referral request to all members of the group that may have knowledge about a referral in question (e.g., send a bike enthusiasts group a referral request for a local bike repair shop). In other instances, the member may only add selected members of a group as trusted connections.

Additionally or alternatively, the hosted service enables members to access another social media network, such as, for example, Linkedin®, Nextdoor, or mother groups to form trusted groups or connections. A member, for example, may add groups (or individual members from the groups) from these other social media networks as trusted connections within a group managed by the referral service. The hosted service may then aggregate trusted members from members that are part of a particular group as a source for providing referrals to a requesting member. For instance, a group exists on Linkedin®. This group does not have a separate space or group at the hosted service. However, the hosted service determines which members of the Linkedin® group are members of the hosted service. The hosted referral service enables a member that is part of the Linkedin® group to request a referral from another member of the Linkedin® group. In this instance, the hosted service determines trusted members as members that are part of the same Linkedin® group irregardless of any association within groups locally managed by the hosted service.

In some instances, the hosted referral service enables a member to specify which trusted connections are associated with which types of products and/or servers to be referred. For instance, a member can specify that trusted connections associated with a similar address correspond to referrals for local professional services, such as landscaping. Thus, only referral requests that are associated with local professional services are routed within the referral service to these trusted connections. It should be appreciated that this configuration enables members to efficiently select which trusted connections receive referral requests, which increases the likelihood of the member receiving an appropriate referral recommendation.

It should be appreciated that the hosted referral service enables relationships to be built between members (and businesses) through the exchange of referrals. It should also be appreciated that the hosted referral service enables members to view collective and/or individual referral activity of trusted connections. For instance, instead of providing a referral request, a member may search referrals provided by a trusted connection. Additionally or alternatively, the member may submit a search query for a referral that causes the hosted service to analyze and locate closely matching previous referrals of trusted connections. The member may then review the results. For instance, a member may request to view referrals of legal services previously provided by trusted connections. In response to the request, the hosted service analyzes previous referrals of trusted connections of the member and provides referrals that include legal services. The referral may include the name (e.g., an identifier) of the service providers, the date the referral was provided, and/or the members to whom the referral was sent.

### Referral Environment

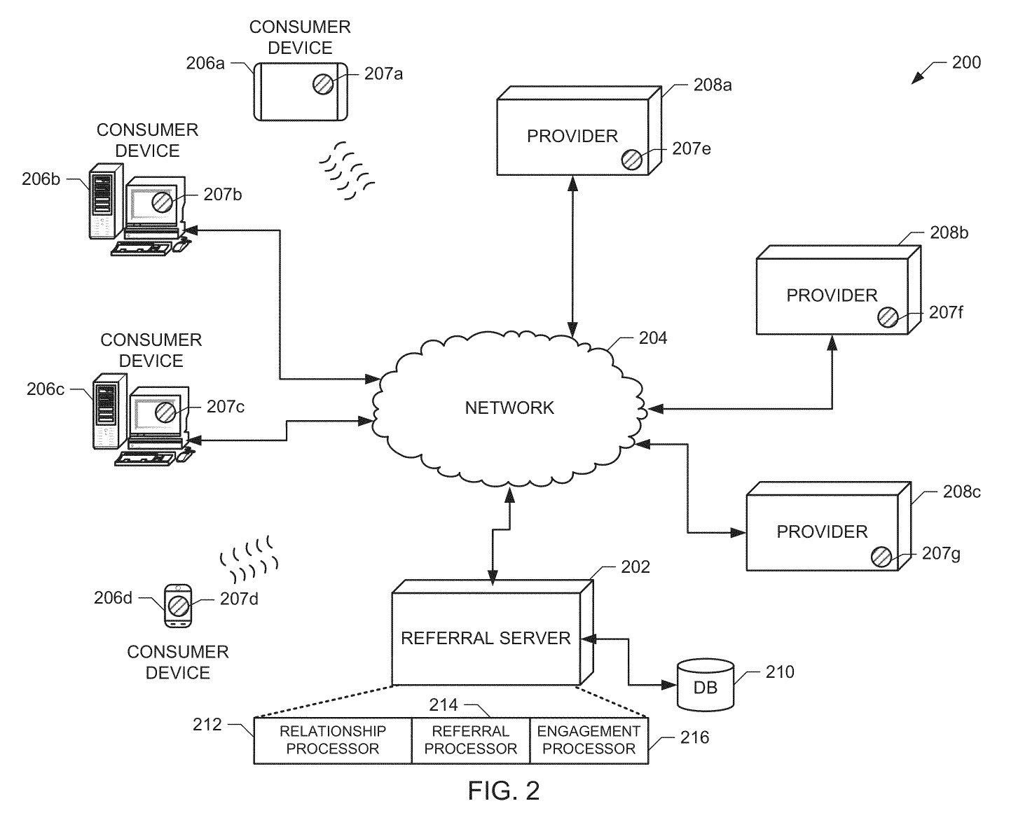

The disclosed hosted referral service may be readily realized in a referral environment. A high level block diagram of an example referral environment 200 is illustrated in FIG. 2. The illustrated environment 200 includes a referral server 202 that is connected via a network 204 (e.g., the Internet) to consumer devices 206 and provider servers/devices 208. It should be appreciated that in other embodiments, the environment 200 can include additional or fewer consumer devices 206 and/or additional or fewer provider servers 208.

The consumer devices 206 of FIG. 2 can include any type of computing device that enables consumers to provide referral information and view referrals. For instance, the consumer devices 206 can include tablet computers, smartphones, smartwatches, smarteyewear, personal computers, laptop computers, servers, processors, gaming consoles, multimedia receivers, etc. The consumer devices 206 may be connected to the network 204 via any wired or wireless connection including, for example, 4G LTE, WiFi, etc.

In this embodiment, at least some of the consumer devices 206 include the referral application 207. The consumer devices 206 receive the referral application 207 from, for example, the referral server 202. For instance, the consumer device 206a registers with the referral server 202 causing the server to transmit the referral application 207a to the device. In other embodiments, the consumer devices 206 receive the referral application 207 from an app store or other entity that enables a consumer to download an application onto their devices.

It should be appreciated that different types of the referral application 207 may be transmitted based on the type of consumer device 206. For instance, the tablet consumer device 206a receives an application 207a configured to operate on a tablet while the smartphone consumer device 206d receives an application 207d configured to operate on a smartphone and the personal computer consumer device 206 receives an application 207b configured to operate on a personal computer. In other embodiments, the referral application 207 may operate in conjunction with (or be replaced by) a website hosted by the referral server 202. In these other embodiments, consumers use the consumer devices 206 to access hosted referral webpages to request and/or provide referrals.

The provider servers 208 of FIG. 2 include any processor, computer, etc. that is associated with an entity that may be the object of a referral (e.g., a provider). For instance, a provider can include a service provider, a retailer, and/or a manufacturer of a product. The provider servers 208 may use the application 207 (or a different provider application) to provide information regarding a product and/or service that is the object of referrals. The provider servers 208 may also use the application 207 to monitor which consumers are referring their products/services. The provider servers 208 may also use the application 207 to advertise or otherwise incentivize consumers into referring their products/services.

The referral server 202 is communicatively coupled to a database 210, which stores data structures of referral information including purchase history, trusted providers, information describing providers, trusted connections for each member, demographic/geographic parameters for each member, and a history of referred products/services for each member, etc. The database 210 may be implemented by any computer-readable medium, including RAM, ROM, flash memory, magnetic or optical disks, optical memory, or other storage media.

The referral server 202 includes one or more processors configured to manage referrals between members including, for example, a relationship processor 212, a referral processor 214, and an engagement processor 216. The referral server 202 (in conjunction with the processors 212 to 216) is configured to host or otherwise provide one or more websites that are accessed by the consumer devices 206 and/or the provider servers 208 to request, respond, or otherwise provide referral information. In other instances, the referral server 202 may manage the deployment and operation of a referral application 207 (e.g., an App) that is provided to the consumer devices 206 and/or the provider servers 208. The application 207 provides a remote operational interface for consumers and/or providers to request, respond, or otherwise provide referral information.

The example relationship processor 212 is configured to create, for example, personal referral groups and local referral groups. Personal referral groups include groups in which individual members have specifically invited other members to be part of the group. The members that are associated with these personal groups become part of a trusted referral team. The personal referral groups may be created for groups of friends/family/coworkers to share referrals. Local referral groups include groups in which individual members share a common background characteristic (e.g., geographic location, hobby, etc.). Generally, members are invited to become members of personal referral groups by other members or become included with a personal referral group by simply becoming a trusted connection of a member that is already part of the group. In contrast, members request to join local referral groups instead of joining through any one member of the group.

The members of the same group become trusted connections of each other. In some instances, the members only become trusted connections of each other with respect to the group. For example, members of a biking group are only trusted connections for referrals regarding biking (or more broadly, the outdoors). In other instances, members of the same group may send unrelated referral requests to members of a particular group.

In some instances the relationship processor 212 may place members within the same group (or ask members if they would like to be placed in a group) based on information ascertained from third-party information sources. For example, the relationship processor 212 (upon receiving permission) may access personal email accounts and social media accounts to determine which members are friends of other members and accordingly create groups for those friends. The relationship processor 212 may also determine the type of relationships between the members to select whether the group is personal or local.

The example referral processor 214 of FIG. 2 is configured to receive referral requests from the consumer devices 206. As discussed herein, the referral requests can include a type of service/product desired, a date the service is desired, a geographic location where the service is to be performed, a service quality level, and/or any particular aspects of the service (e.g., carpenter with knowledge of restoring Victorian homes). The example referral processor 214 is configured to determine whether the referral request is to be transmitted to members within a personal referral group or members within a local referral group based, for instance, on the type of the provider and the location. The example referral processor 214 is also configured to transmit a referral request message to consumer devices 206 of members of the determined referral group.

In an example, the referral processor 214 is configured to determine a referral request is to be transmitted to a local referral group conditioned on a type of provider, specified in a request, having an attribute (e.g., a profile characteristic provided by the provider) that matches a background characteristic of the local referral group. The referral processor 214 is configured to determine that a referral request is to be transmitted to a personal referral group conditioned on the type of provider, specified in a request, matching types of providers previously referred to by members of that personal referral group. Additionally, the referral processor 214 is configured to determine a referral request is to be transmitted to a personal referral group after receiving an instruction from a requesting member indicating that a particular personal referral group should receive the referral request. In some instances, the referral processor 214 is configured to receive a subset message from a consumer device 206 of a referral requesting member indicating that a referral request message is to be transmitted to a specified subset of a determined referral group.

The example engagement processor 216 is configured to manage the referral replies from the trusted connections and enable a member to reach out and schedule service via a specified provider. In some instances, the engagement processor 216 may use the response information from the trusted connections as a basis to search for other profile information regarding the provider. In these instances, the engagement processor 216 is configured to provide a member that made a request with identifiers of service providers in conjunction with other profile information such as contact information, pricing, examples of work, etc. For example, the engagement processor 216 may receive an engagement request message from a consumer device 206 and accordingly transmit a service request message to the provider device 208. The engagement processor 216 may also maintain a data structure of referral requests, referral responses, and an indication of which provider was ultimately selected by the requesting member.

The processors 212 to 216 operating collectively as the referral server 202 are configured, in one embodiment, to receive a request message from a consumer device 206 of a first member. The request may identify a service type the member is seeking a referral. The referral server 202 determines a group of members that are trusted connections of the requesting member. The group of members may include one or more personal and/or local referral groups that the requesting member is subscribed to or enrolled. The referral server 202 may also determine a first subset of the trusted connections that includes trusted connections that have experience with the requested service type (e.g., members that have personal experience performing the requested service), a second subset of the trusted connections that includes trusted connections that are connected to at least one of a member or a provider associated with the service type, (e.g., members that are connected to other members that perform the requested service), and/or determine a third subset of the trusted connections that includes trusted connections that have previously referred providers associated with the requested service type.

After identifying trusted connections that are associated with the service type, the referral server 202 is configured to enable a member to view, sort, and/or filter the connections based on a filter attribute. The referral server 202 is configured to determine if the trusted connections at least meet the criteria specified in the filter attribute and transmits referral requests to those trusted connections. The filter attributes can include, for example, an experience level associated with a service type, a relevance to a service type, and/or a degrees of separation between a trusted connection and a member associated with a service type. For example, a member may specify in a referral request that a pediatrician is sought with at least ten years of experience. The referral server 202 is configured to remove (or reduce the value of) trusted connections that are themselves general doctors, pediatrician with less than 10 years experience, or trusted connections with connections to those who are not pediatrician with at least 10 years of experience.

The example referral server 202 of FIG. 2 is configured to transmit referral request messages to trusted connections that at least match referral request information provided by a member and/or trusted connections that have been individually selected (or selected via a group). The example referral server 202 then compiles referral response messages from the trusted connections and provides these referral responses to the requesting member. The referral server 202 may compile the response messages for a specified period of time (e.g., two days) before no longer accepting responses. The specified time period may be set by the requesting member when specifying criteria for the referral request.

The example referral server 202 is also configured to manage the transmission of follow up messages between a member and trusted connections. For example, after receiving referral responses, the requesting member may send messages to those that have responded with specific questions regarding the referrals, to which the trusted connections may respond via the referral server 202. The referral server 202 further enables the requesting member to contact a selected provider to schedule a service and/or order a product.

The example referral server 202 is further configured to manage the collection of fees from members and/or providers. In an embodiment the server 202 may charge members different subscription fees for different levels of functionality and/or access. In another embodiment, the referral server 202 may collect a fee from each provider every time that provider is recommended by a member. The referral server 202 may also collect a fee from a provider every time a member uses a referral to schedule a service provided by the provider. In some instances, the fee may be proportional to the cost of the product and/or service, or alternatively, the fee may be a fixed rate.

While the referral server 202 is shown as a single component, in other embodiments the referral server 202 may include multiple servers across one or more distributed networks. Further, the referral server 202 may be implemented in a cloud computing framework. Features of the referral server 202 are further described in more detail in conjunction with FIGS. 3 to 19.

FIG. 3 shows a diagram 300 of functions that are provided by the referral server 202 and/or the application 207 to the consumer devices 206. The functions are classified into membership functions 302, referral functions 304, trusted connection functions 306, and search functions 308. As discussed above, membership functions 302 include registration, social integration, and/or social publishing (which includes posting referral information to other social media services).

The referral functions 304 may be used by the relationship processor 214 and are configured to enable consumers to associate with other members and provide referrals. As discussed herein, members can be part of two different types of referral groups: personal and local. Personal referral groups include individual members specifically invited by a member to be associated with that member and group. The members that are associated with these personal groups become part of a trusted referral team.

Local referral groups include individual members that form or request to join a group (rather than associate with another individual). These groups are designed for members who share a similar profile trait, background characteristic, etc. The local referral groups accordingly enable members to associate with a relatively large number of members that share similar profiles without having to associate (or know) each member individually. Members may automatically be included within the group. Alternatively, a moderator of the group may determine which members may be included.

In addition to adding members through personal and local groups, the hosted referral service provided by the server 202 enables members to request and receive referral feedback from trusted members that are part of the groups. This includes a request for a second opinion regarding a specific service and/or product. The hosted service also enables members to search and view referrals previously provided by trusted connections to other members. In some instances, the server 202 may make available previously made referrals between trusted connections of a member. In other instances, the server 202 provides all referrals made from a trusted connection regardless of whether the member receiving the referral is a trusted connection of the member.

The example referral server 202 is configured to enable members to make referrals for providers that are registered providers of the referral service and providers that have not yet registered. Regarding unregistered providers, the referral server 202 enables any member to add information regarding the provider so that the member may provide a referral for that provider. The referral server 202 may query the unregistered provider after a user has provided the provider's information to get the provider to ultimately register with the referral server 202.

The trusted connection functions 306 of the diagram 300 of FIG. 3 include functions that enable members to manage trusted connections, add trusted providers to a referral list, view trusted providers of trusted connections, and provide support for trusted providers. As disclosed herein, a member can use the referral server 202 to visually provide support for providers. A trusted provider is displayed, for example, by the referral server 202 in a list of trusted providers on a profile or account page of a member. Inclusion within the list indicates to trusted connections of the member that the provider is trusted. Additionally, the referral server 202 may display on a page of the provider a list of members who have added the provider and a trusted provider. Moreover, a member can provide a written, audio, and/or video recommendation for a trusted provider that is displayed on an account page of the member and/or the provider.

The search functions 308 of the diagram 300 of FIG. 3 include search features provided by the referral server 202. A member may search for referrals based on, for example, profession, provider type, service type, product type, product name, referral action, and/or referral group. It should be appreciated that the referral server 202 may provide additional searching capabilities including searching by a date range, geographic location, trusted connection profile information (e.g., age), etc.

FIG. 4 shows a diagram 400 of functions that are provided by the referral server 202 and/or the application 207 to the provider servers 208. The functions include a membership function 402, a referrals management function 404, a referral marketing function 406, a scheduled broadcast function 408, and an e-commerce function 410. The membership function 402 enables the provider servers 208 to register with the server 202, integrate referral activities with another social media entity, publish information, and manage recommendations provided by members. The referrals management function 404 enables the providers to view referrals made between members, influence or incentivize referrals from members, schedule referral requests from members, and create referral partnerships with another provider.

The referral marketing function 406 provided by the server 202 enables the provider servers 208 to incorporate referral functionality on other websites and/or applications. For instance, a provider server 208 can request for the server 202 to transmit a request to a third-party website to include a ‘refer’ button. A member that selects the button may add the provider as a trusted provider and/or may refer to the provider to another member. In a particular example, a retailer website provides a product manufactured by a provider associated with server 208a. The provider can request that the server 202 send instructions to the retailer website to add a ‘refer’ button associated with the provider. Members that view the product may refer the product to other members (or non-members) by selecting the ‘refer’ button and providing the appropriate information to make the referral. In another example, the provider server 208b may operate a website (e.g., a dentist website). The provider can request the server 202 to add the ‘refer’ button. Members can then select the ‘refer’ button enabling the server 202 to provide referral functionality so that the member can refer the provider to other members (or non-members).

The referral marketing function 406 may also enable a provider to create at the referral server 202 a social and/or virtual business card. For example, the referral server 202 may enable a provider to create a data structure that includes contact information, business information, and/or promotion information. A member may select to send a copy of the data structure and/or a link to the data structure as part of a referral response. The referral server 202 may also display the business card in conjunction to a business webpage for the provider.

In addition to providing ‘refer’ button functionality, the referral server 202 may also enable the provider servers 208 to manage leads among the members. A lead includes a member that receives a referral for a provider and opts into receiving offers and/or messages from the provider. A lead may also include a member that opts into receiving offers and/or messages without having received a referral from a provider. A provider uses leads to incentivize or otherwise request members to provide referrals for the provider.

The scheduled broadcasts function 408 of the diagram 400 is a function provided by the server 202 that enables the provider servers 208 to manage content provided across different social media platforms (e.g., Facebook®, Twitter®, etc.). This can include broadcasting across different social media sites one or more incentives to particular members to provide a referral. The e-commerce function 410 of the diagram 400 enables the provider servers 208 to use the server 202 to facilitate transactions resulting from referrals. These transactions can include coupons or certificates for a discount based on business generated from a referral. These transactions can also include rewards to members who provide referrals.

### Referral Environment Functional Relationships

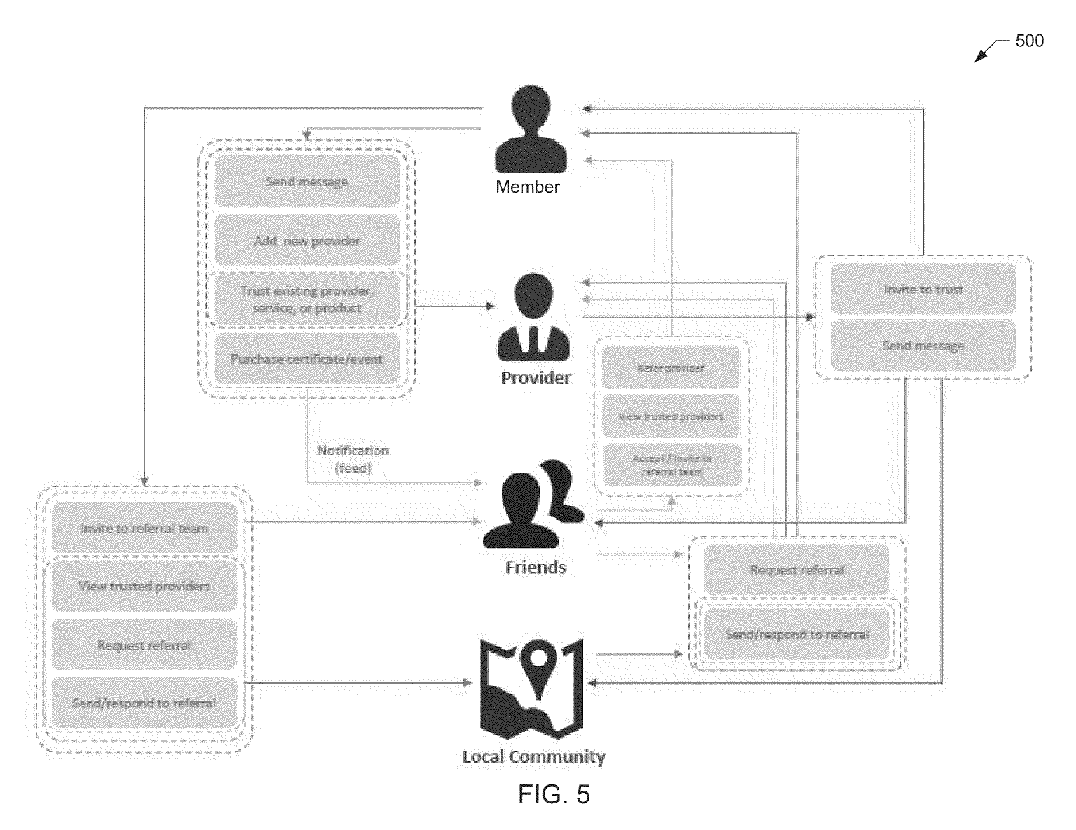

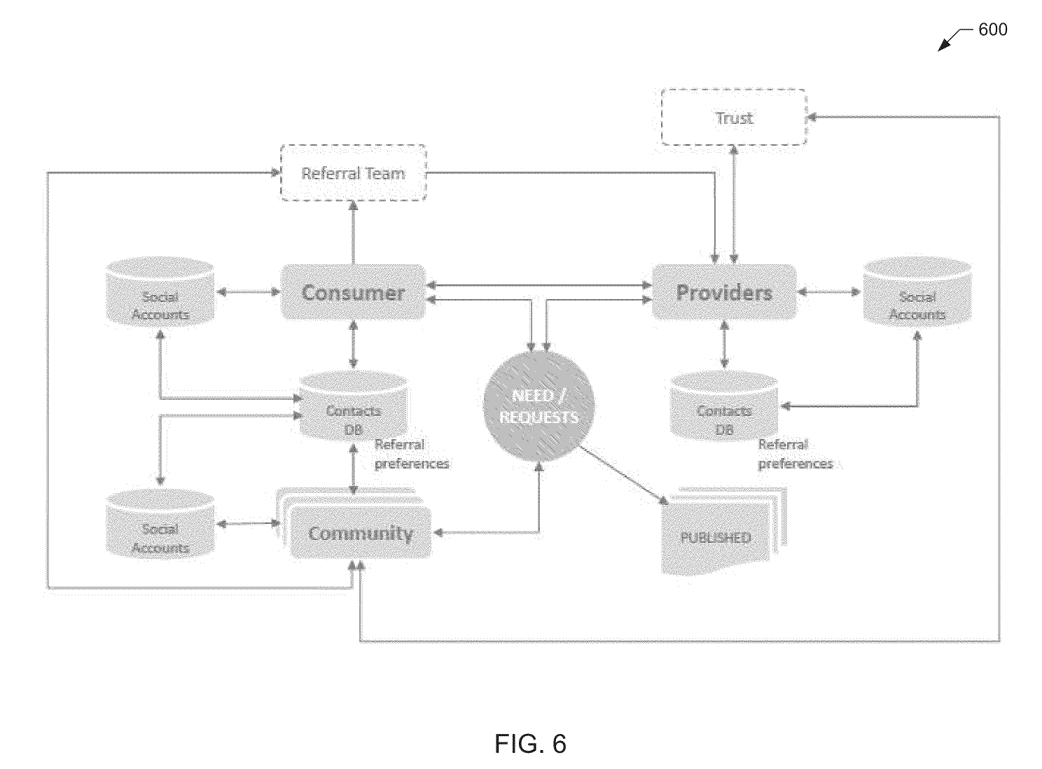

FIGS. 5 and 6 show diagrams 500 and 600 of example relationships among the members, providers, trusted connections (e.g., Friends) and groups (e.g., local communities managed by the server 202 and/or groups managed by third-party social media networks). As shown, the server 102 enables the members using consumer devices 206 to send messages requesting referrals, add a new provider, add a member as a trusted connection, indicate that a provider is trusted, and/or purchase a referred product and/or service. The example server 202 routes these actions in conjunction with the appropriate provider servers 208. Additionally, the server 202 may publish any of these actions on a news feed viewable by trusted connections of the member.

The server 202 also enables a member to invite a trusted connection to a referral local group, view trusted providers of other members, request referrals from a local group, search previous referrals, and/or respond to referrals. The local server 202 also enables a provider to send messages, referral information, requests for referrals, and/or incentives to members and/or local referral groups. The example server 202 further enables members to send messages to trusted connections, local referral groups, and/or a provider.

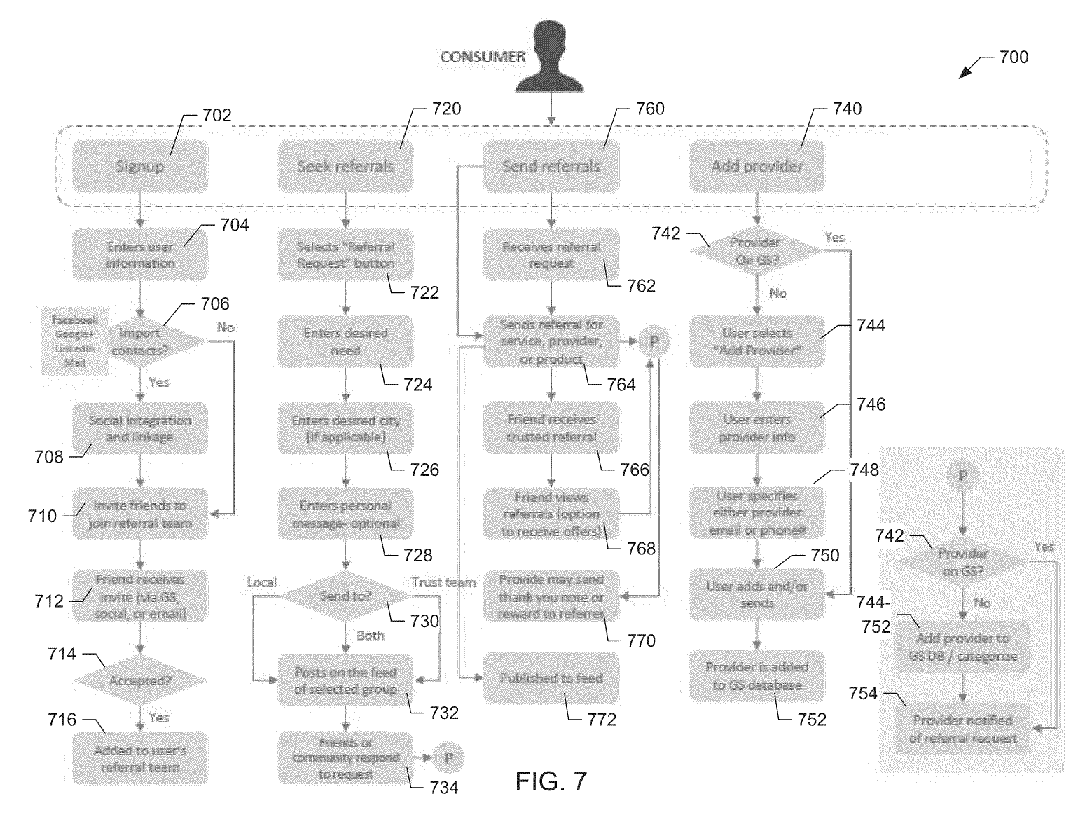

FIG. 7 shows a flow diagram illustrating an example procedure 700 operated by the example referral server 202 based on which function is selected by a member via consumer device 206, according to an example embodiment of the present disclosure. The example procedure 700 may be carried out by, for example, the referral server 202 and the consumer devices 206 described in conjunction with FIGS. 1 to 6. Although the procedure 700 is described with reference to the flow diagram illustrated in FIG. 7, it will be appreciated that many other methods of performing the functions associated with the procedure 700 may be used. For example, the order of many of the blocks may be changed, certain blocks may be combined with other blocks, and many of the blocks described are optional.

When a consumer uses a signup function 702, the example server 202 operating the procedure 700 prompts the consumer for information (block 704). As described above, the information can include profile information, bibliographic information, background characteristics, interests, etc. The information can also include previous purchases and/or contact information of the corresponding provider. The server 202 also determines if the newly registered member wants to import contacts from another social media application (block 706). If the member expresses a desire to import contacts, the server 202 accesses the social media website and imports the member's contacts (block 708). For contacts that are already members, the referral server 202 may send a request to the members asking them to accept the newly registered member as a trusted connection (block 710). Alternatively, the server 202 may add these contacts as trusted connections because there is already an association with the member. For contacts that are not already members, the referral server 202 may send a message to the contacts asking them to become registered members (blocks 712, 714, and 716).

The example referral server 202 also enables the member to invite friends or other members to join a personal referral team. The server 202 further enables the member to join one or more local referral groups. Moreover, the server 202 enables the member to accept requests to become a trusted connection of another member.

When a member uses the seek referrals function 720, the example server 202 prompts the member to provide the desired service type and/or product type (blocks 722 and 724). The referral server 202 may also prompt the member for a geographic location, date/time during which the referral is needed, desired cost, and/or a personal message (blocks 724, 726, and 728). The referral server 202 then enables the member to select whether the request should be transmitted to personal trusted connections and/or one or more local referral groups (block 730). In some instances, the server 202 may determine which local referral groups and/or trusted connections would be appropriate for the request based on previous referrals for a similar (or the same) product type and/or service, geography, previous referrals provided to the member, etc.

The example server 202 then transmits the request to the appropriate members and/or groups (block 732). Additionally or alternatively, the example server 202 posts the request to a feed or wall on a page associated with the appropriate trusted members. The example server 202 next collects referral responses (block 734). The example server 202 may queue the responses to provide a one or few responses to the member. Alternatively, the referral server 202 may transmit the responses to the member as they are received. It should be appreciated the request and responses are text messages, e-mails, or messages posted to account pages of the corresponding members.

For each response, the referral server 202 performs a provider function 740. For instance, the referral server 202 determines whether the referred provider is a registered provider (block 742). If the provider is not registered, the server 202 adds the provider's information (provided by the referring member) to a data structure of available providers (blocks 744, 746, 748, 750, and 752). The server 202 may also send a message to the provider 202 requesting that the provider become a registered member. For registered providers, the referral server 202 transmits a notification of the referral which includes, for example, the time/date of the referral, an identifier of a member making the referral, an identifier of a member receiving the referral, and/or the local referral group associated with the member providing the referral (block 754). The provider may provide an offer to the member responsive to the referral being made. At this point, the member requesting the referral selects one of the referred providers. Selecting can include using information within the referral to contact the provider, accessing a link provided within the referral to view a webpage and/or product page associated with the provider, etc.

Regarding the transmission of a referral function 760, the example server 202 transmits a request of the referral to the member (blocks 762 and 764). The server 202 then receives a response from the member with the referral and provides the referral to the requesting member (block 766 and 768). A provider may use the server 202 to send the member making the referral a thank you message and/or reward for providing the referral (block 770). The reward could include money, a coupon, and/or points. The points could be managed by the server 202 and be redeemable for goods and/or services. The server 202 may also publish to a feed of the requesting member and/or the member making the referral an indication of the referral so that other members can view the referral (block 772).

### User Interface Embodiments

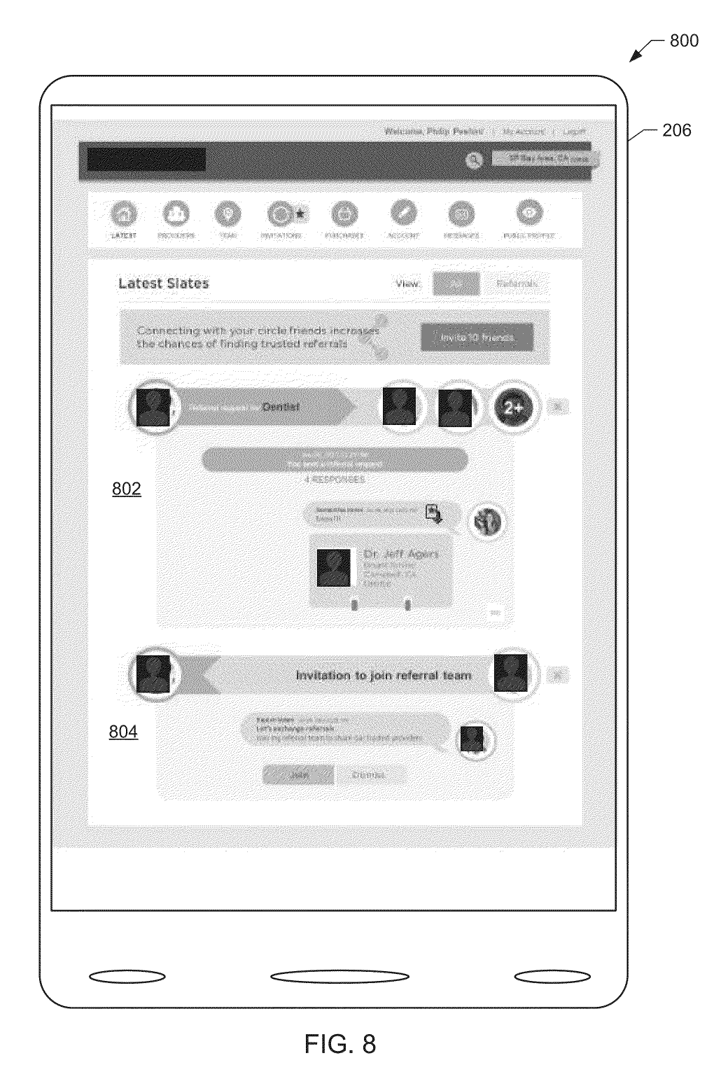

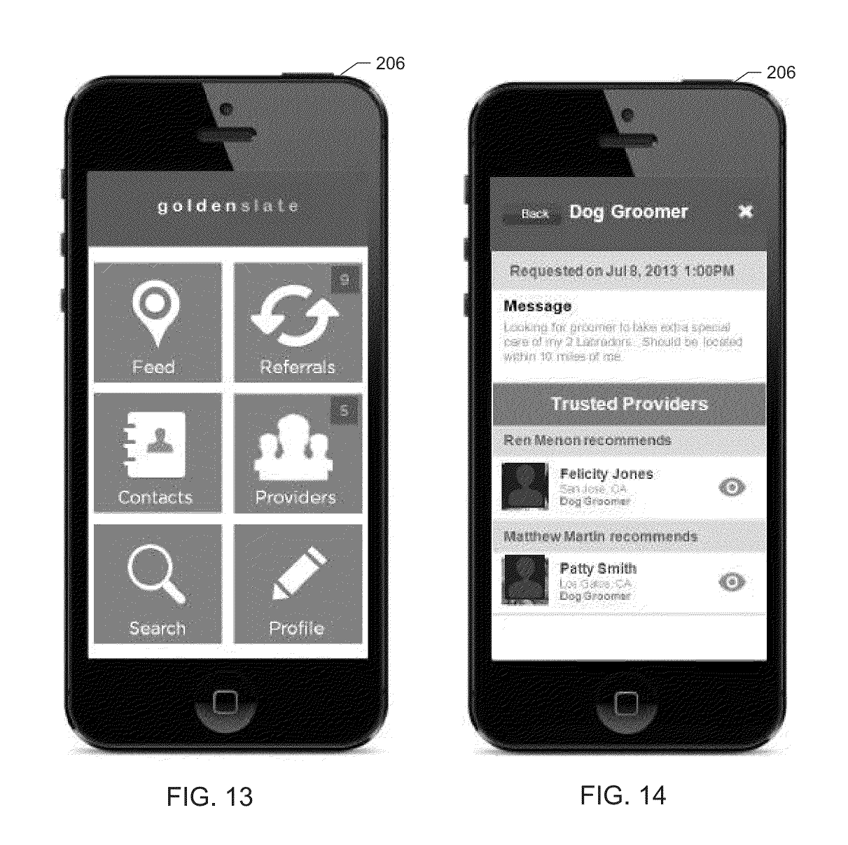

FIGS. 8 to 14 show diagrams of example user interfaces of a consumer device 206 displaying referral information provided and/or managed by the referral server 202 of FIG. 2. It should be appreciated that FIGS. 8 to 14 are only example embodiments and that in other instances, the look and feel, functionality, and/or layout of the user interfaces may change based on the functions supported by the referral server 202 and/or capabilities of the consumer device 206. For instance, FIGS. 8 to 12 show user interfaces configured for a tablet computer or laptop while FIGS. 13 and 14 show user interfaces configured for a smartphone.

FIG. 8 shows diagram of a user interface that includes a dashboard 800 for a member. The example dashboard 800 provides links to referral functionality and includes information associated with the member's account. In particular, the dashboard 800 of FIG. 8 includes a section 802 that summarizes responses for a dentist referral request previously initiated by the member. The dashboard 800 also includes a section 804 that indicates another member is requesting that the member become part of his personal referral group. In other instances, the dashboard 800 can include local referral group activity, referral responses provided by the member, messages from other members, messages from providers, advertisements from providers, etc.

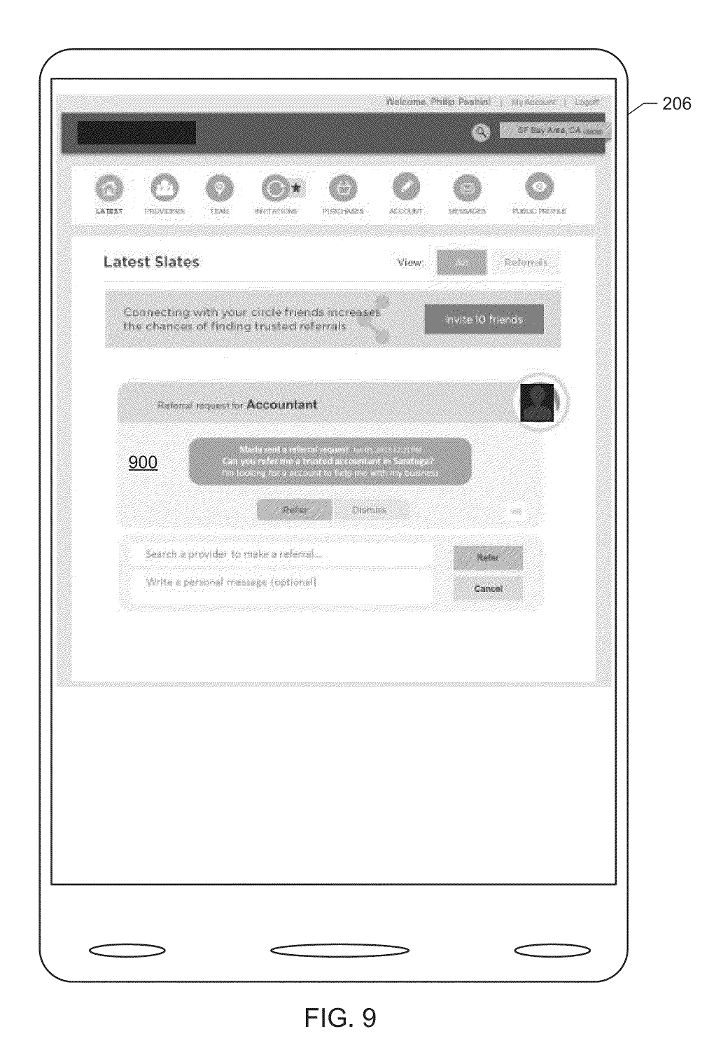

FIG. 9 shows a user interface that includes a referral response function 900. In this embodiment, a member can respond to a referral request by selecting the appropriate response function in the dashboard 800 of FIG. 8 and providing response information. In other embodiments, the member may select the response function in another social media application that is configured to generate referral request messages managed by the referral server 202.

In this illustrated example, the referral response function 900 includes an identification of a product or service type that is the object of the request. The referral response function 900 may also include a message provided by the requesting member and/or any other information associated with the request (e.g., member profile information, geographic information, etc.). The referral response function 900 also includes response options for the member to either respond or dismiss the request.

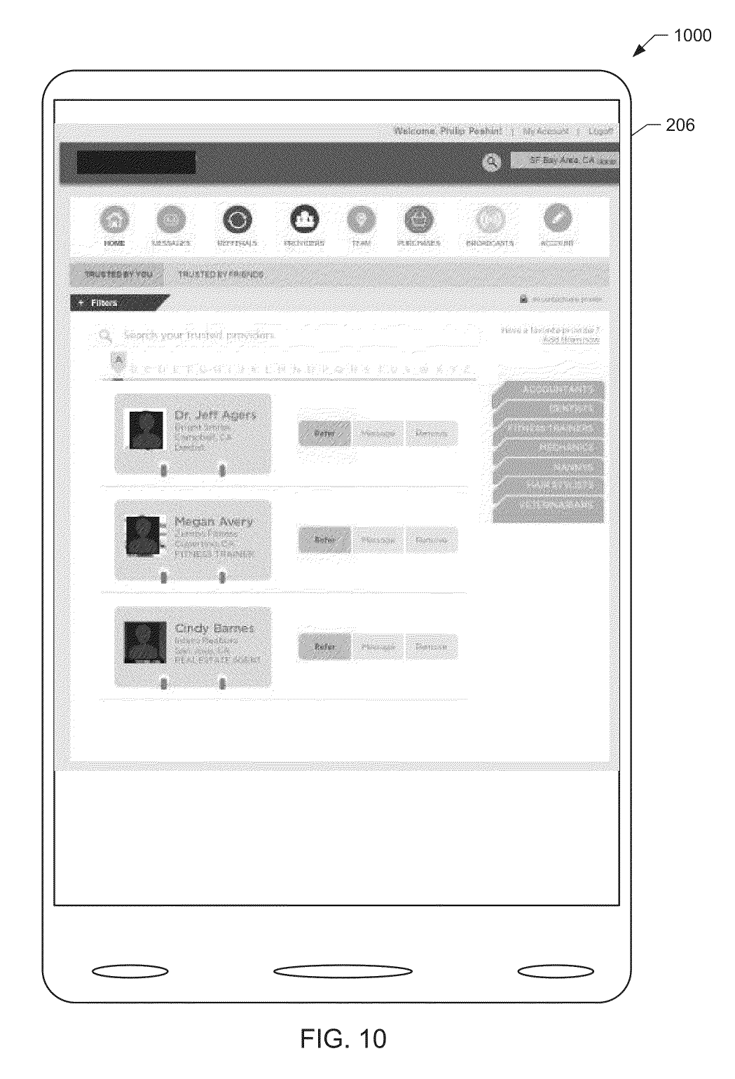

If the member selects the refer function, the referral server 202 and/or application 207 provides functionality in the referral response function 900 that enables the member to search for a provider to make the referral. Searching for the provider may include enabling the member to view a data structure of providers previously referred by the member, trusted providers of the member, and/or all providers registered with the referral server 202. For example, FIG. 10 shows a user interface 1000 that includes a list of trusted providers available for selection by the member. It should be appreciated that the referral server 202 may filter the providers based on the requested service and/or product type.

If the member is unable to locate a provider, the member may enter the provider's information including, for example, a name, e-mail address, phone number, physical address, etc. In some examples, the referral server 202 may use the provider information provided by the member and search websites to acquire further information. For instance, a member may only provide the name and address of a provider. The referral server 202 may supplement this information by searching the Internet for a website and/or e-mail address for the provider. The referral server 202 then adds this information with the information provided by the member.

As mentioned above, FIG. 10 shows a user interface 1000 of trusted providers for a member. The trusted providers may include providers that the member has previously referred and/or providers that the member has specifically indicated as being trusted. In some instances, the referral server 202 requests or prompts the member to specify trusted providers. In other instances, the referral server 202 may determine potential trusted providers by analyzing an e-mail or credit card account of the member to search for providers. The referral server 202 may than query the member as to whether the identified providers are to be labeled as trusted.

In this example, the user interface 1000 enables the member to search providers alphabetically and by profession or service type. In other instances, the user interface 1000 may include a search box that enables a member to provide at least a portion of the provider's name or other information. The user interface 1000 may also include filters that enable a member to view only providers referred within a previous time period, providers within a geographic location, etc.

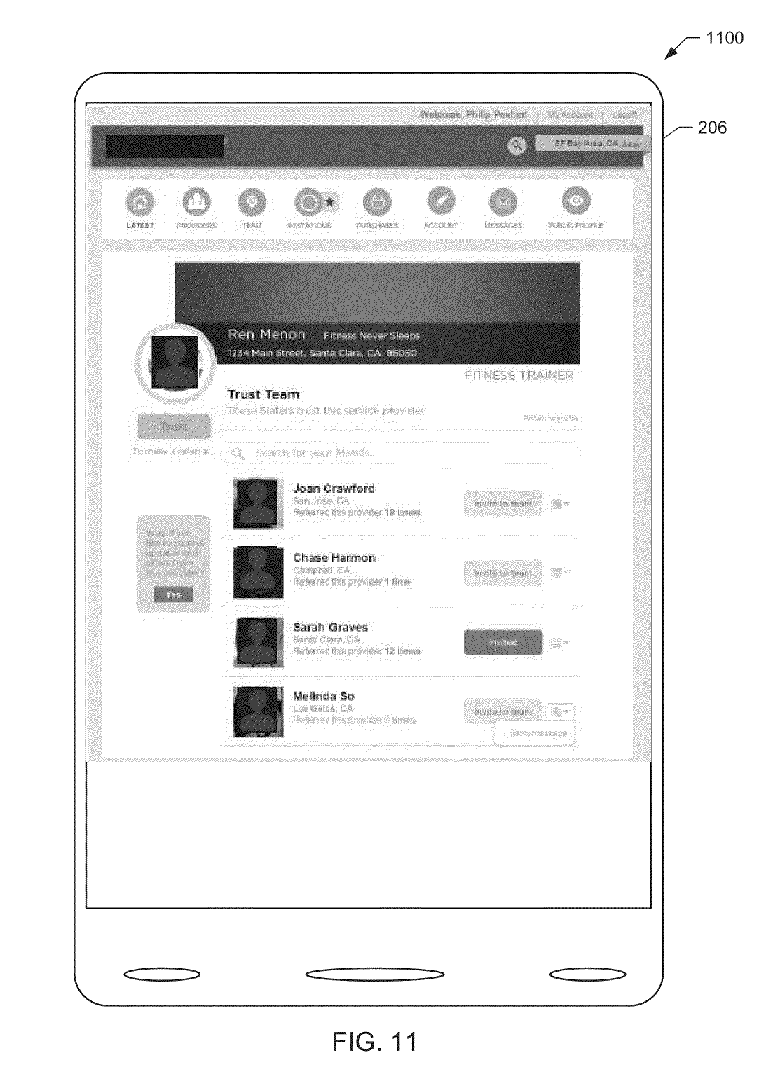

The example user interface 1000 of FIG. 10 also enables the member to view trusted providers of trusted connections. In some instances, the trusted providers are shown in aggregate for all of the trusted connections. In these instances, the user interface 1000 may indicate which of the trusted connections trusts the provider. FIG. 11 shows a diagram of a user interface 1100 indicating which members and trusted connections trust a provider named ‘Ren Menon’. This interface 1100 also indicates the number of times each of the members or connections have referred the provider. It should be appreciated that the interface 1100 includes members that are not trusted connections of the member. In other instances, the user interface 1100 may only show trusted connections.

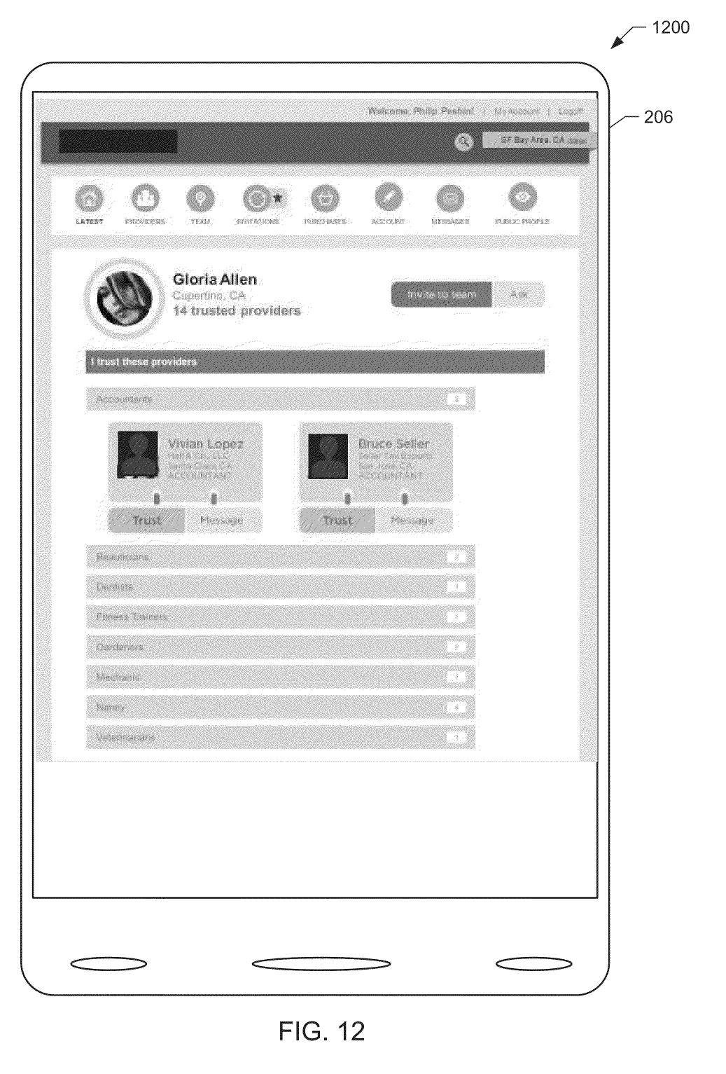

The example server 202 may alternatively display to a member trusted providers of a particular trusted connection. For instance, FIG. 12 shows a diagram of a user interface 1200 of trusted providers of a member's trusted connection. The user interface 1200 may also indicate a number of times the trusted connection referred each of the providers.

As discussed above, the format or configuration of the user interfaces may be dependent upon the consumer device 206. FIGS. 13 and 14 are diagrams that show user interfaces formatted for a smartphone. In particular, FIG. 13 shows a dashboard of a member and FIG. 14 shows a request user interface that displays referral responses to a member's request for a dog groomer.

While the layout varies from the user interfaces shown in conjunction with FIGS. 8 to 12, the functionality of the user interfaces in FIGS. 13 and 14 is substantially similar. It should also be appreciated that functionality between the application 207 and a website hosted by the referral server 202 is substantially the same and may be interrelated. For instance, the application 207 may communicate with the server 202 to exchange referral messages.

### Embodiments for Displaying Referrals with Third-Party Content

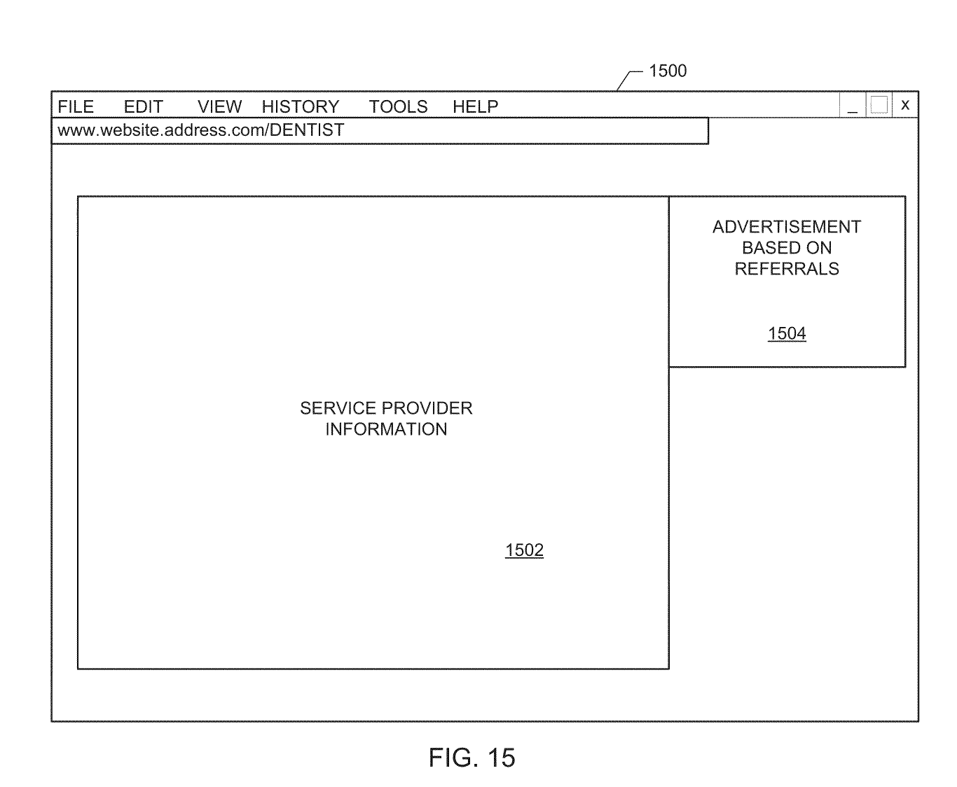

FIGS. 15 to 17 show diagrams of user interfaces 1500, 1600, and 1700 that include third-party content displayed in conjunction with referrals managed by the referral server 202 of FIG. 2. The user interfaces 1500, 1600, and 1700 may be associated with (e.g., managed/hosted) third-party servers and/or provider servers 208 and displayed by the consumer devices 206 The user interfaces 1500, 1600, and 1700 are only examples of how referrals may be displayed in conjunction with third-party content. In other examples, third-party servers can display referrals in any manner in relation to the content displayed on a website or an application. For instance, a merchant server may display referrals in a pop-up window or in a widget adjacent to a product page that sequences through referrals.

FIG. 15 shows a user interface 1500 provided by a service provider. The interface 1500 is shown as a webpage displayed within a web browser. In this example, the interface 1500 includes a service provider section 1502 that includes text, links, and/or pictures associated with one or more services offered by the provider. The interface 1500 also includes an advertisement section 1504 that displays referral information to consumers.

In an example, a member of the referral service accesses the webpage shown within the interface 1500 by entering the webpage address of ‘www.website/address.com/dentist’ into a web browser on a consumer device 206. A provider server 208 associated with the webpage address transmits the webpage content to the consumer device 206. The provider server 208 operates in conjunction with the referral server 202 to identify the member. Based on the member, the referral server 202 determines referrals provided by trusted connections of the member that are associated with the service provider. For instance, the referral server 202 may indicate how many (and which) trusted connections have referred the particular service provider.

Alternatively, the referral server 202 may provide other service providers (e.g., dentists) that have been referred by the trusted connections. This alternative embodiment enables service providers to advertise to members based on previous referral history. A member may select the advertisement in the section 1504 to launch a website hosted by the referral server 202 and/or visit a website associated with the advertisement shown in the section 1504.

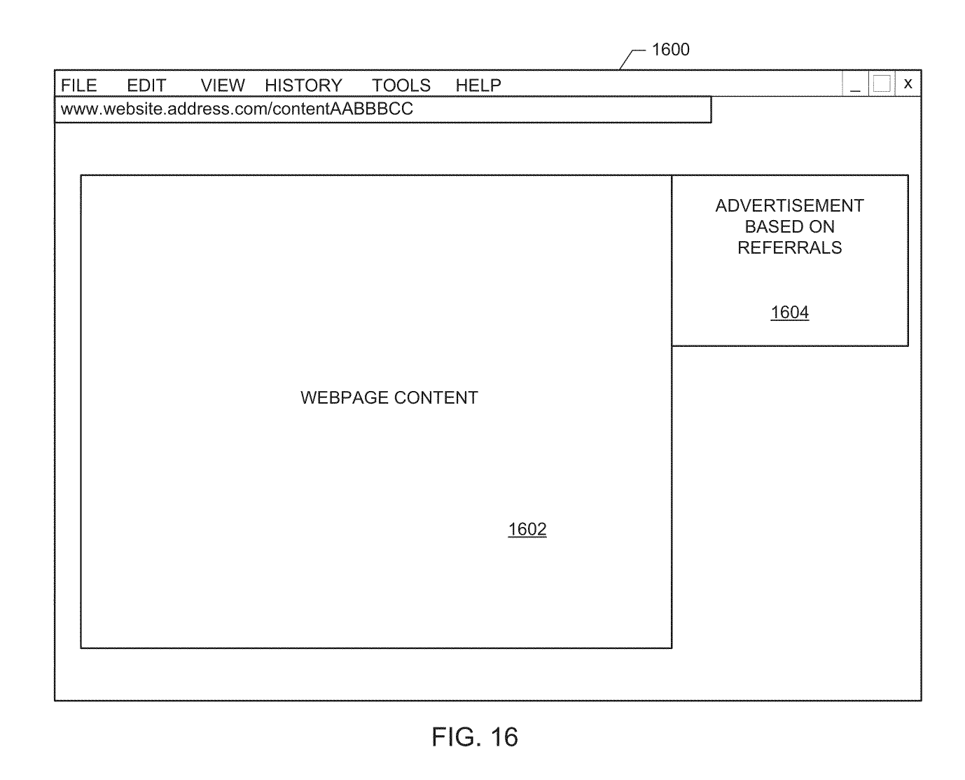

FIG. 16 shows a user interface 1600 provided by a content provider. The content provider provides any type of webpage content including for example, news, blogs, social media information, user generated content, etc. The content is displayed within a content section 1602 of the interface 1600. An advertising entity owns (or leases) space adjacent to the content section 1602 including advertisement section 1604. An advertising server associated with the advertising entity selects which advertisements are displayed within the section 1604.

Similar to the embodiment of FIG. 15, the referral server 202 operates in conjunction with the advertising server to determine which member is viewing the webpage and selects a referred provider for display within section 1604. The referral server 202 may select a referral based on content within the section 1602, a provider that leased advertisement time for the section 1604, a product/service category designated for the section 1604, etc. A selection of a referral shown within the advertising section 1604 causes the advertising server to redirect the member to a webpage associated with the product/service and/or a website operated by the server 202 and/or the provider.

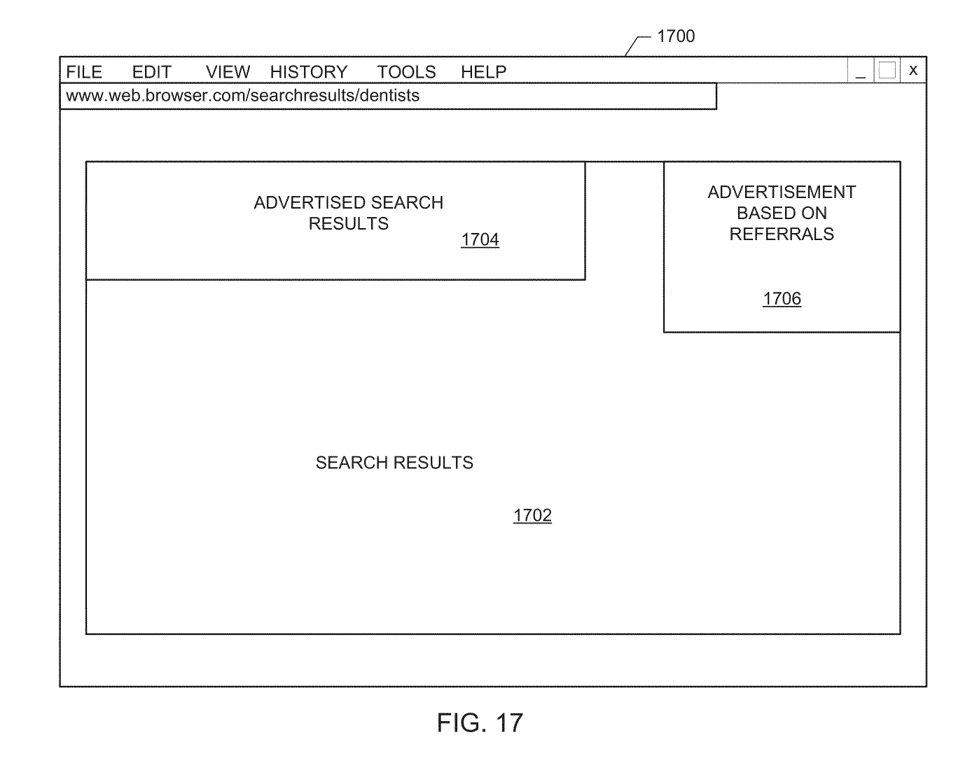

FIG. 17 shows a user interface 1700 provided by a search engine operator. The user interface 1700 includes a search results section 1702 configured to display search results for a member of the referral service. The user interface 1700 also includes an advertised search results section 1704 and an advertisement section 1706. The referral server 202 operates in conjunction with a search server to provide referrals based on search terms provided by the member.

For instance, in FIG. 17 a member searches for dentists. The referral server 202 determines an identity of the member and matches the identity to referrals provided by trusted connections and/or local referral groups. The referral server 202 operating in conjunction with the search server selects one or more referrals for dentists and displays these referrals within sections 1704 and 1706. For example, the search server displays links to referred dentists within advertised search results section 1704. The search server also displays an advertisement for one or more dentists within the advertisement section 1706.

### Third-Party Review Aggregation Embodiment

In an embodiment, the example referral server 202 of FIG. 2 is configured to aggregate ratings of providers from third-party websites and/or applications. The referral server 202 uses the aggregated ratings to create, for example, a referral rating that is displayable in conjunction with a hosted provider webpage. Further, the referral server 202 may enable the aggregated rating to be included with a referral response.

Moreover, the referral server 202 may use the aggregated rating in provider searches. For instance, the referral server 202 may enable a member to search for providers referred by trusted connections that have a rating above a certain level (e.g., four-stars). Responsive to a member search request, the referral server 202 accordingly filters results for only providers that have an aggregated rating equal to or grater than the specified threshold.

In an example, the referral server 202 scrapes, crawls, requests, or otherwise obtains ratings from third-party websites for specified providers. In some instances, the referral server 202 may only search for ratings for registered providers, providers referred by members, and/or ratings provided by members to the third-party websites. Alternatively, the referral server 202 may obtain ratings for all providers included within the third-party website. The referral server 202 may transmit registration prompts to any providers with a rating (or a rating above a threshold) that are not already registered. Examples of third-party websites include Yelp®, Angie's List®, Contractor.com™, Metromix®, Google®, Yellow Pages®, Amazon®, or any other website that enables users to post reviews. The third-party website may also include a website managed by the provider.

The example referral server 202 collects reviews from each of the third-party websites and determines an aggregated rating. The referral server 202 may assign a weight to rankings from each third-party website based on which third-party website was associated with the ratings and/or reviews, a number of reviews, a number of reviews provided by members, a time of each review (with more recent reviews receiving more weight), whether a provider responded to a review, etc. Alternatively, the referral server 202 may determine the aggregated rating based on an overall rating provided by the third-party website.

After determining an aggregated rating, the example referral server 202 displays the rating in conjunction with the provider. The referral server 202 may also provide one or more hyperlinks to the reviews for the provider on the third-party website. In some instances, the referral server 202 may combine the aggregated rating with ratings and/or referrals provided by members through the hosted referral service. Alternatively, the referral server 202 may show the aggregated rating in conjunction to ratings and/or referrals by members. For instance, the referral server 202 may display on a provider webpage that the provider has a three-star rating on third-party websites and a four-star referral rating by members. The referral server 202 accordingly can leverage relatively large number of reviews and/or rankings to provide members additional data to assist those members making a purchasing decision.

### Processor

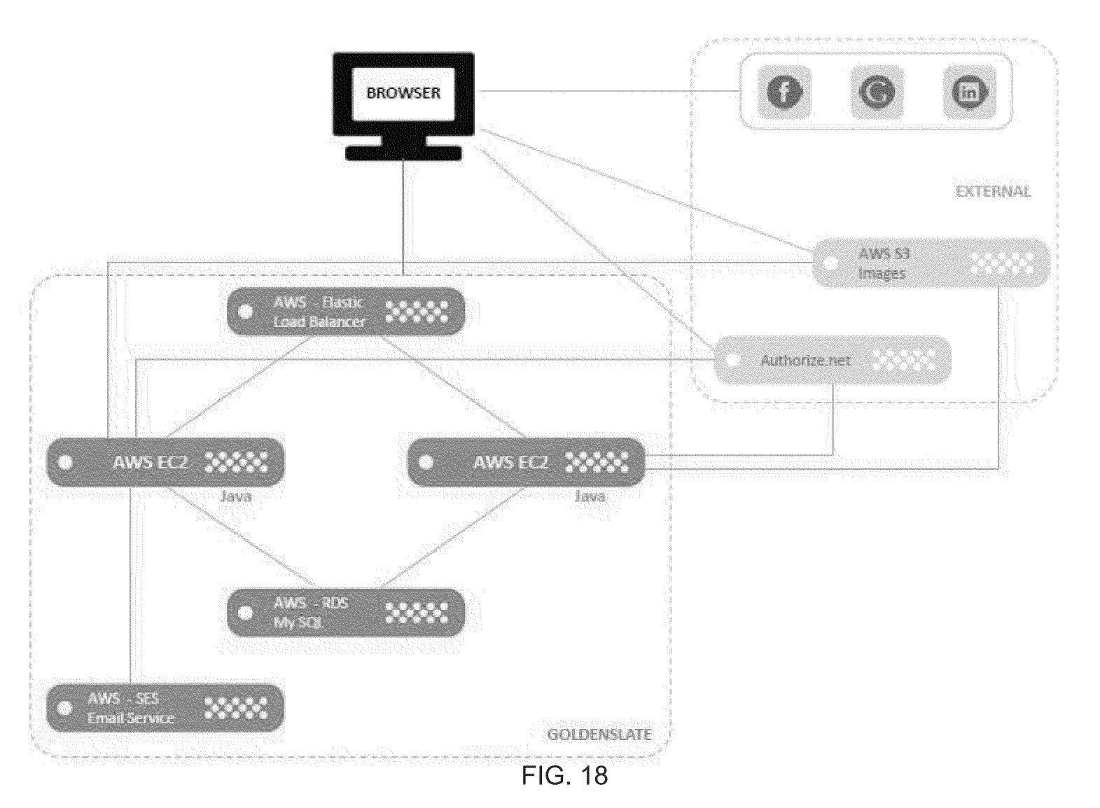

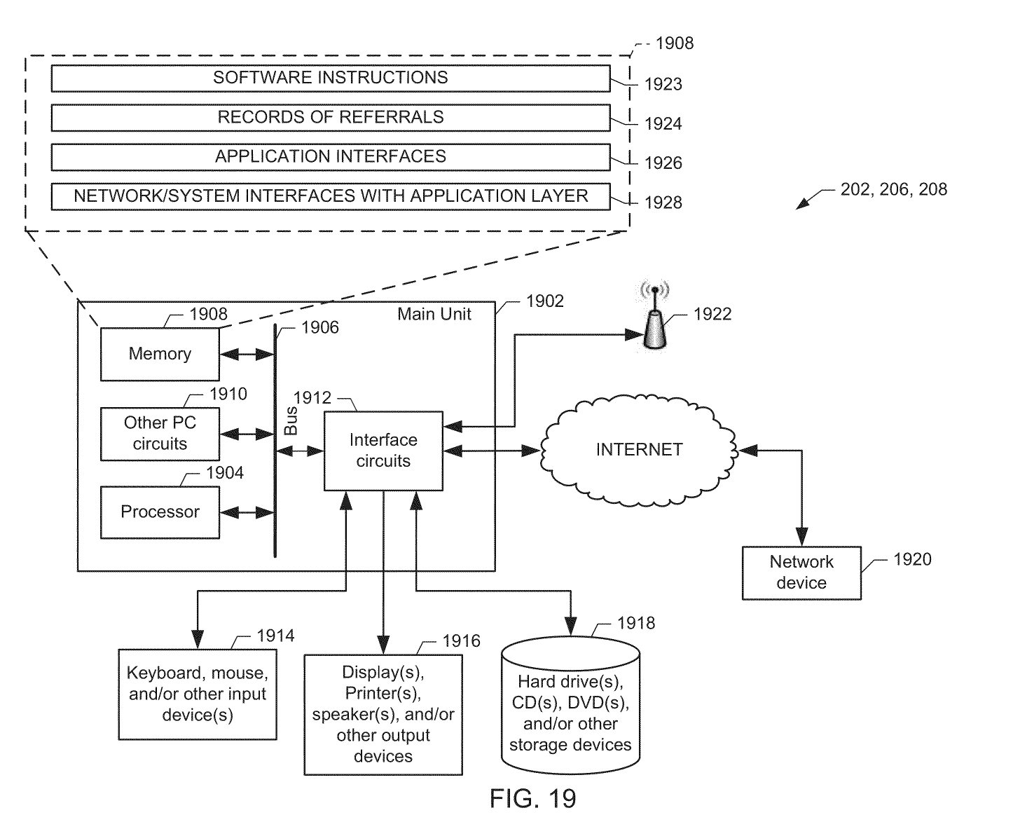

A detailed block diagram of electrical systems of an example computing device (e.g., a referral server 202, a consumer device 206, and/or a provider server 208) is illustrated in FIGS. 18 and 19. In this example, the referral server 202, the consumer device 206, and/or the provider server 208 includes a main unit 1902 which preferably includes one or more processors 1904 communicatively coupled by an address/data bus 1906 to one or more memory devices 1908, other computer circuitry 1910, and one or more interface circuits 1912. The processor 1904 may be any suitable processor, such as a microprocessor from the INTEL PENTIUM® or CORE family of microprocessors.

The memory 1908 preferably includes volatile memory and non-volatile memory. Preferably, the memory 1908 stores a software program(s) that interacts with the other devices in the environment 200, as described above. This program may be executed by the processor 1904 in any suitable manner. As shown in FIG. 18, memory 1908 may be part of a “cloud” such that cloud computing may be utilized by the referral server 202, the consumer device 206, and/or the provider server 208. The memory 1908 may also store digital data associated with referral history, member profiles, provider information, programs, group information, preferences, behaviors, meta-data, web pages, etc. retrieved from the referral server 202, the consumer device 206, and/or the provider server 208 and/or loaded via an input device 1914.

The example memory devices 1908 store software instructions 1923, records of referral server requirements 1924, consumer interface features, member connection records, permissions, protocols, configurations, preference information, and/or application interface information 1926 (e.g., information for accessing and using a referral application). The memory devices 1908 also may store network or system interface features, permissions, protocols, configuration, and/or network interface information 1928 for use by the referral server 202, the consumer device 206, and/or the provider server 208. It will be appreciated that many other data structures and records may be stored in the memory device 1908 to facilitate implementation of the methods and apparatus disclosed herein. In addition, it will be appreciated that any type of suitable data structure (e.g., a flat file data structure, a relational database, a tree data structure, etc.) may be used to facilitate implementation of the methods and apparatus disclosed herein.

The interface circuit 1912 may be implemented using any suitable interface standard, such as an Ethernet interface and/or a Universal Serial Bus (USB) interface. One or more input devices 1914 may be connected to the interface circuit 1912 for entering data and commands into the main unit 1902. For example, the input device 1914 may be a keyboard, mouse, touch screen, track pad, track ball, isopoint, image sensor, character recognition, barcode scanner, microphone, and/or a speech or voice recognition system.

One or more displays, printers, speakers, and/or other output devices 1916 may also be connected to the main unit 1902 via the interface circuit 1912. The display may be a cathode ray tube (CRTs), a liquid crystal display (LCD), or any other type of display. The display generates visual displays generated during operation of the referral server 202, the consumer device 206, and/or the provider server 208. For example, the display may provide a user interface and may display referrals received from consumer devices 206 of trusted connections. A user interface may include prompts for human input from a user of the consumer device 206 including links, buttons, tabs, checkboxes, thumbnails, text fields, drop down boxes, etc., and may provide various outputs in response to the user inputs, such as text, still images, videos, audio, and animations.

One or more storage devices 1918 may also be connected to the main unit 1902 via the interface circuit 1912. For example, a hard drive, CD drive, DVD drive, and/or other storage devices may be connected to the main unit 1902. The storage devices 1918 may store any type of data, such as purchase history, records, requirements, transaction data, operations data, salable item information, statistical data, security data, etc., which may be used by the referral server 202, the consumer device 206, and/or the provider server 208.

The referral server 202, the consumer device 206, and/or the provider server 208 may also exchange data with other network devices 1920 via a connection to the Internet or a wireless transceiver 1922 connected to the Internet. Network devices 1920 may include one or more servers, which may be used to store certain types of data, and particularly large volumes of data which may be stored in one or more data repository. A server may include any kind of data including databases, programs, files, libraries, records, images, documents, requirements, referral data, operations data, configuration data, index or tagging data, provider information, statistical data, security data, etc. A server may store and operate various applications relating to receiving, transmitting, processing, and storing the large volumes of data. It should be appreciated that various configurations of one or more servers may be used to support and maintain the system 200. For example, servers may be operated by various different entities. Also, certain data may be stored in the referral server 202, the consumer device 206, and/or the provider server 208 which is also stored on a server, either temporarily or permanently, for example in memory 1908 or storage device 1918. The network connection may be any type of network connection, such as an Ethernet connection, digital subscriber line (DSL), telephone line, coaxial cable, wireless connection, etc.

Access to the referral server 202, the consumer device 206, and/or the provider server 208 can be controlled by appropriate security software or security measures. An individual users' access can be defined by the referral server 202, the consumer device 206, and/or the provider server 208 and limited to certain data and/or actions. Accordingly, users or consumers of the environment 200 may be required to register with one or more of the referral server 202, the consumer device 206, and/or the provider server 208.

### CONCLUSION

It will be appreciated that all of the disclosed methods and procedures described herein can be implemented using one or more computer programs or components. These components may be provided as a series of computer instructions on any conventional computer-readable medium, including RAM, ROM, flash memory, magnetic or optical disks, optical memory, or other storage media. The instructions may be configured to be executed by a processor, which when executing the series of computer instructions performs or facilitates the performance of all or part of the disclosed methods and procedures.

It should be understood that various changes and modifications to the example embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A referral apparatus comprising:
a relationship processor configured to:
create a personal referral group among a first member and a first plurality of members causing the first member and the first plurality of members to be trusted connections of each other with respect to the personal referral group, the personal referral group created based on one of the first plurality of members inviting the first member become a trusted connection, and
create a local referral group including the first member and a second plurality of members causing the first and second plurality of members to be trusted connections of each other with respect to the local referral group, the local referral group being created for members with a common background characteristic;
a referral processor configured to:
receive from a consumer device of the first member a referral request including a type of provider needed and a location where a service is to be performed,
determine whether the referral request is to be transmitted to members within the personal referral group or members within the local referral group based on the type of the provider and the location, and
transmit a referral request message to consumer devices of members of the determined referral group; and
an engagement processor configured to:
receive a response message from at least one of the consumer devices that received the referral request message, the response message including an identifier of a provider of the type of provider specified in the referral request message,
determine profile information associated with the identifier of the provider, and
transmit a request response message to the consumer device of the first member including the profile information.

2. The referral apparatus of claim 1, wherein the similar background characteristic includes at least one of a geographic location, a profile trait, a demographic characteristic, a hobby, a profession, and a personal interest.

3. The referral apparatus of claim 1, wherein the engagement processor is further configured to:
receive an engagement request from the consumer device after transmitting the request response message; and
transmit a service request message to a device of the provider.

4. The referral apparatus of claim 1, wherein the referral processor is configured to determine the referral request is to be transmitted to the local referral group conditioned on the type of provider having an attribute that matches the similar background characteristic.

5. The referral apparatus of claim 1, wherein the referral processor is configured to determine the referral request is to be transmitted to the personal referral group conditioned on the type of provider matching types of providers previously referred to by members of the personal referral group.

6. The referral apparatus of claim 1, wherein the referral processor is configured to determine the referral request is to be transmitted to the personal referral group after receiving an instruction from the first member indicating that the personal referral group should be selected.

7. The referral apparatus of claim 1, wherein the referral processor is configured to receive a subset message from the consumer device of the first member indicating that the referral request message is to be transmitted to a specified subset of the determined referral group.

8. A method comprising:
receiving at a referral server a request message from a consumer device of a first member, the request message identifying a service type;
determining, via the referral server, a group of members that are trusted connections of the first member;
determining, via the referral server, a first subset of the trusted connections that includes trusted connections that have experience with the service type;
determining, via the referral server, a second subset of the trusted connections that includes trusted connections that are connected to at least one of a member or a provider associated with the service type;
transmitting, via the referral server, a referral request message to consumer devices associated with the trusted connections of the first subset and the second subset;
receiving, via the referral server, a referral response message including an identifier of a provider of the requested service type from at least one of the client devices that received the referral request message; and
transmitting, via the referral server, a request response message to the consumer device of the first member including the identifier of the provider.

9. The method of claim 8, further comprising:
determining, via the referral server, a third subset of the trusted connections that includes trusted connections that have previously referred providers associated with the service type; and
transmitting, via the referral server, the referral request message to consumer devices associated with the trusted connections of the third subset.

10. The method of claim 8, further comprising:
before transmitting the referral request message, transmitting, via the referral server, identifiers of the trusted connections of the first subset and the second subset to the consumer device of the first member;
receiving, via the referral server, a selection message from the consumer device of the first member identifying at least one of the trusted connections of the first subset and the second subset; and
transmitting, via the referral server, the referral request message to only the consumer devices of the trusted connections selected by the first member.

11. The method of claim 8, further comprising:
receiving, via the referral server, from the consumer device of the first member a filter attribute;
before transmitting the referral request message, determining, via the referral server, which of the trusted connections of the first subset and the second subset at least meet the filter attribute; and
transmitting, via the referral server, the referral request message to only the consumer devices of the trusted connections that match the filter attribute.

12. The method of claim 8, wherein the filter attribute includes at least one of an experience level associated with the service type, a relevance to the service type, and a degrees of separation between the trusted connection and a member associated with the service type.

13. The method of claim 8, wherein
receiving the request message includes receiving a request via an account of the first member provided by a hosted service operated by the referral server;
transmitting the referral request message includes making the referral request available at accounts of the trusted connections of the first subset and the second subset;
receiving the referral response message includes receiving a referral response via the account of one of the trusted connections that received the referral request message; and
transmitting the request response message includes making the referral response message available at the account of the first member.

14. The method of claim 8, wherein the request message includes an identification of a product type and the referral response message includes an identification of a specific product associated with the product type.

15. The method of claim 8, wherein the request message includes at least one of a specific product and a specific provider and the referral response message includes an indication as to whether the trusted member recommends the at least one of the specific product and the specific service provider.

16. A machine-accessible device having instructions stored thereon that, when executed, cause a machine to at least:
receive a referral request message to consumer device of a first member, the referral request having been created by a second member that is a trusted connection of the first member;
determine a service type specified by the referral request message;
determine a group of providers associated with the service type that the first member has previously recommended;
making the group of providers available for the first member to select via the consumer device;
receiving a selection of at least one of the providers within the group of providers; and
transmitting a referral response message including an identifier of each selected provider.

17. The machine-accessible device of claim 16, further comprising instructions stored thereon that are configured when executed to cause the machine to:
receive an identifier of a provider from the consumer device of the first member that has not been previously recommended by the first member;
determine the received identifier corresponds to a registered provider; and
transmitting the referral response message including the identifier of the registered provider.

18. The machine-accessible device of claim 16, further comprising instructions stored thereon that are configured when executed to cause the machine to:
receive an identifier of a provider from the consumer device of the first member that has not been previously recommended by the first member;
determine the received identifier corresponds to an unregistered provider; and
determine profile information associated with the unregistered provider;
transmitting the referral response message including the profile information of the unregistered provider.

19. The machine-accessible device of claim 18, further comprising instructions stored thereon that are configured when executed to cause the machine to determine the profile information associated with the unregistered provider by accessing a website associated with the unregistered provider.

20. The machine-accessible device of claim 18, further comprising instructions stored thereon that are configured when executed to cause the machine to transmit a membership message to a device of the unregistered provider prompting the unregistered provider to become a registered provider.
